(19) United States
(12) Patent Application Publication
(10) Pub. No.: US 2007/0035073 A1
(43) Pub. Date: Feb. 15, 2007

(54) Isolation for electric motor

(76) Inventors: Jeffrey Charles Kinmartin, East Amherst, NY (US); Edward Douglas Pettitt, Burt, NY (US); Garrett Wade Hoehn, Kenmore, NY (US)

Correspondence Address: DELPHI TECHNOLOGIES, INC., M/C 480-410-202, PO BOX 5052, TROY, MI, 48007, US

(21) Appl. No.: 11/200,550

(22) Filed: Aug. 10, 2005

(51) Int. Cl. F16M 1/00

(52) U.S. Cl. 267/136; 267/292

(57) ABSTRACT

The invention provides an isolator for isolating vibration associated with an electric motor. The isolator includes a first body portion operable to be positioned adjacent to an external surface of a motor case of the electric motor. The isolator also includes a tongue integrally formed with and narrower than the first body portion. The tongue is operable to be received in a groove formed in the motor case. The isolator also includes a second body portion integrally formed with and wider than the tongue. The second body portion is operable to be disposed adjacent an internal surface of the motor case. As a result, at least a portion of the motor case of the electric motor is disposed between the first and second body portions.

### FIELD OF THE INVENTION

The invention relates to electric motors and more particularly to an isolator for vibrationally isolating an electric motor.

### BACKGROUND OF THE INVENTION

Electric motors often produce vibrational energy in a frequency related to the harmonics of the number of windings within the motor. This vibrational energy can be transmitted to the structure of the component to which the electric motor is attached such that it causes the component to vibrate and emit noise. This can occur with automotive HVAC modules wherein the blower motor causes an objectionable tone noise to occur.

### SUMMARY OF THE INVENTION AND ADVANTAGES

The invention provides an isolator for isolating vibration associated with an electric motor. The isolator includes a first body portion operable to be positioned adjacent to an external surface of a motor case of the electric motor. The isolator also includes a tongue integrally formed with and narrower than the first body portion. The tongue is operable to be received in a groove formed in the motor case. The isolator also includes a second body portion integrally formed with and wider than the tongue. The second body portion is operable to be disposed adjacent an internal surface of the motor case. As a result, at least a portion of the motor case of the electric motor is disposed between the first and second body portions.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a top view of a first exemplary embodiment of an isolator according to the invention;

FIG. 2 is a perspective view of the first exemplary isolator engaged with a motor case of an electric motor;

FIG. 3 is a perspective cut-away view of the first exemplary isolator engaged with a motor case of an electric motor and with an vehicle HVAC module;

FIG. 4 is a perspective view of a second exemplary embodiment of an isolator according to the invention engaged with a motor case of an electric motor;

FIG. 5 is a perspective view of a third exemplary embodiment of an isolator according to the invention;

FIG. 6 is a perspective cut-away view of a fourth exemplary embodiment of an isolator according to the invention engaged with a motor case of an electric motor; and

FIG. 7 is a perspective view of the fourth exemplary isolator engaged with a motor case and a brush card of an electric motor.

### DETAILED DESCRIPTION OF THE PREFERRED EMBODIMENT

A plurality of different embodiments of the invention are shown in the Figures of the application. Similar features are shown in the various embodiments of the invention. Similar features have been numbered with a common reference numeral and have been differentiated by an alphabetic designation. Also, to enhance consistency, features in any particular drawing share the same alphabetic designation even if the feature is shown in less than all embodiments. Similar features are structured similarly, operate similarly, and/or have the same function unless otherwise indicated by the drawings or this specification. Furthermore, particular features of one embodiment can replace corresponding features in another embodiment unless otherwise indicated by the drawings or this specification.

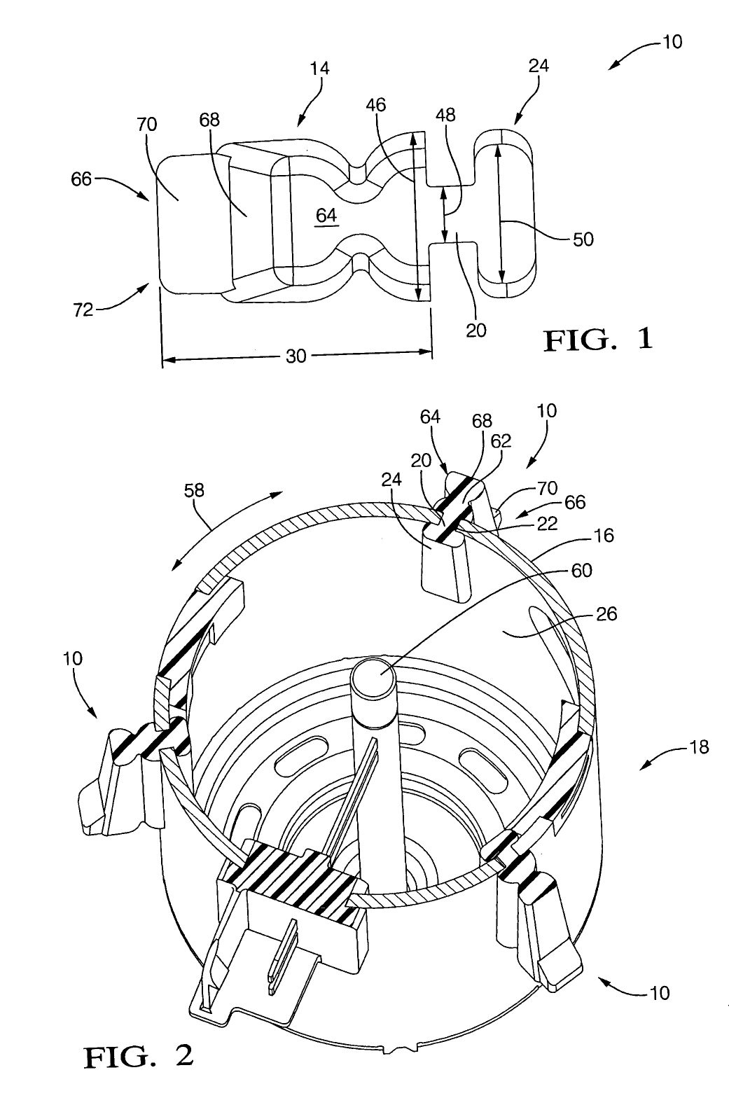

Referring now to FIGS. 1-3, in a first exemplary embodiment of the invention, an isolator 10 is operable to isolate vibration associated with an electric motor 12. The isolator 10 includes a first body portion 14 operable to be positioned adjacent to an external surface 16 of a motor case 18 of the electric motor 12. The isolator 10 also includes a tongue 20 integrally formed with and narrower than the first body portion 14.

The first body portion 14 defines a first width 46 and the tongue defines a second width 48 less than the first width 46. The tongue 20 is operable to be received in a groove 22 formed in the motor case 18. The isolator 10 also includes a second body portion 24 integrally formed with and wider than the tongue 20. The second body portion 24 defines a third width 50 greater than the second width 48. The second body portion 24 is operable to be disposed adjacent an internal surface 26 of the motor case 18. As a result, at least a portion of the motor case 18 of the electric motor 12 is disposed between the first and second body portions 14, 24.

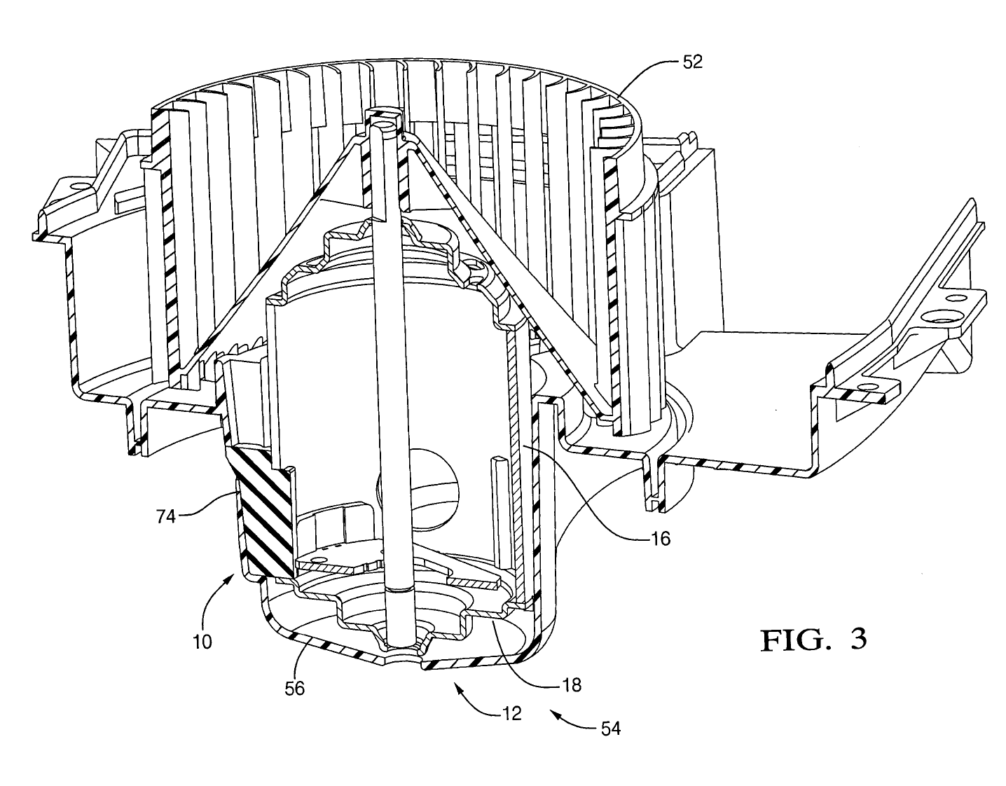

As best shown in FIG. 3, the electric motor 12 is engaged with a blower 52 in an HVAC module 54. The electric motor 12 is positioned in a housing 56 of the HVAC module 54. The isolator 10 is disposed between the electric motor 12 and the housing 56 to isolate vibrational energy associated with the electric motor 12 from the housing 56. Only one isolator 10 is visible in FIG. 3; however, a plurality of isolators 10 can be disposed evenly spaced around the motor case 18, as best shown in FIG. 2.

As best shown in FIG. 2 with respect to the first exemplary embodiment of the invention, the structure of the isolator 10 allows for relatively simple assembly to the motor case 18. The isolator 10 can be slidably received in the groove 22. The first and second body portions 14, 24 extend in a direction corresponding to the shape of the motor case 18. In the first exemplary embodiment, the first and second body portions 14, 24 extend substantially straight and parallel to one another.

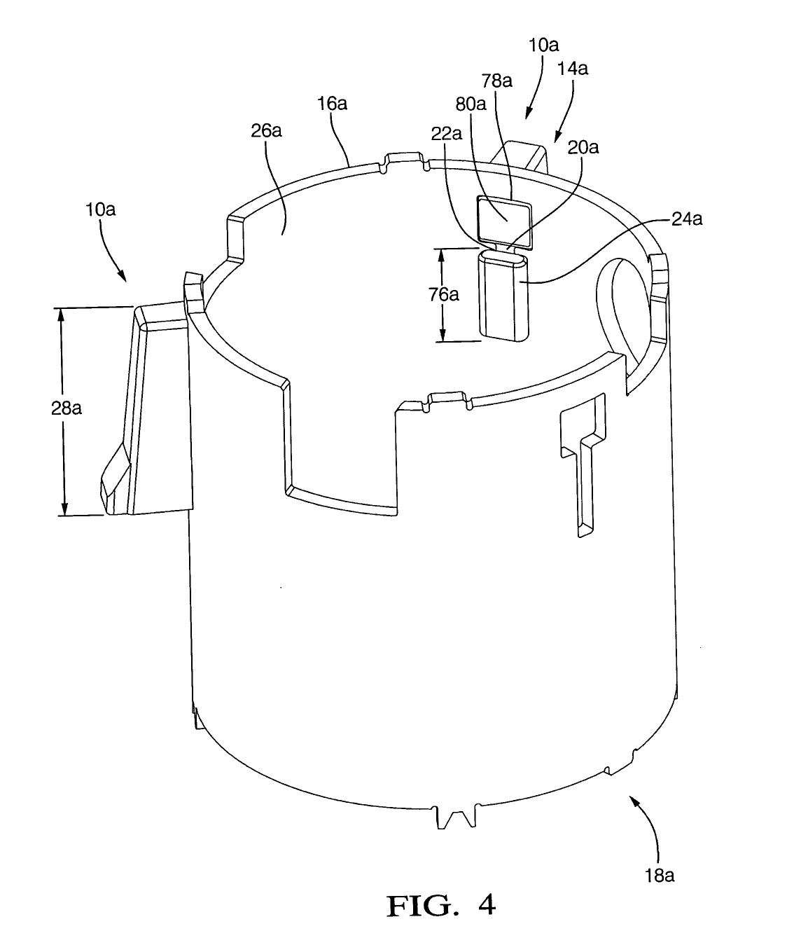

The first body portion 14 extends a first length (such as first length 28a of the second exemplary embodiment shown in FIG. 4) and has an hour-glass cross-section along at least a portion of the first length. In operation, the electric motor 12 may experience forces urging rotational movement 58 about a shaft 60 of the electric motor 12. The neck portion 62 of the hour-glass cross-section accommodates slight twisting while maintaining relatively more rigid resistance to forces urging movement of the electric motor 12 in an axial direction, such as along the shaft 60.

The first body portion 14 extends the first length and has a first height 30. The first height 30 is variable along the first length. The first height 30 continuously increases along the first length from a first end 64 of the first body portion 14 to a second end 66. The first height 30 increases at first rate along a first portion 68 of the first length and increases at second rate greater than the first rate along a second portion 70 of the first length adjacent to the first portion 68. The change in the first height 30 along the first length can enhance assembly of the electric motor 12 in the housing 56. For example, the radially outward surface 72 of the first body portion 14 that is defined by the first height 30 can engage an inner surface 74 of the housing 56 to guide installing movement of the electric motor 12 relative to the housing 56. Also, the ramped, second portion 70 can accommodate irregularities in the surface 74 and/or manufacturing inconsistencies.

Referring now to FIG. 4, in a second exemplary embodiment of the invention, an isolator 10a is operable to isolate vibration associated with an electric motor, such as electric motor 12 associated with the first exemplary embodiment of the invention. The isolator 10a includes a first body portion 14a operable to be positioned adjacent to an external surface 16a of a motor case 18a of the electric motor. The isolator 10a also includes a tongue 20a integrally formed with and narrower than the first body portion 14a. The tongue 20a is operable to be received in a groove 22a formed in the motor case 18a. The isolator 10a also includes a second body portion 24a integrally formed with and wider than the tongue 20a. The second body portion 24a is operable to be disposed adjacent an internal surface 26a of the motor case 18a. As a result, at least a portion of the motor case 18a of the electric motor is disposed between the first and second body portions 14a, 24a.

In the second exemplary embodiment of the invention, the first body portion 14a is longer than the second body portion 24a. The first body portion 14a extends a first length 28a and the second body portion 24a extends a second length 76a less than the first length 28a. Also, the tongue 20a is shorter than the first body portion 14a. During assembly of the isolator 10a to the motor case 18a, the second body portion 24a can be inserted in an aperture 78a. The aperture 78a communicates with the groove 22a. A protrusion 80a can extend radially inwardly from the first body portion 14a. The protrusion 80a can be shaped to correspond to the shape of the aperture 78a . During assembly of the isolator 10a to the motor case 18a, the protrusion 80a can snap into the aperture 78a when the tongue 20a reaches a bottom of the groove 22a to enhance the engagement between the isolator 10a and the motor case 18a.

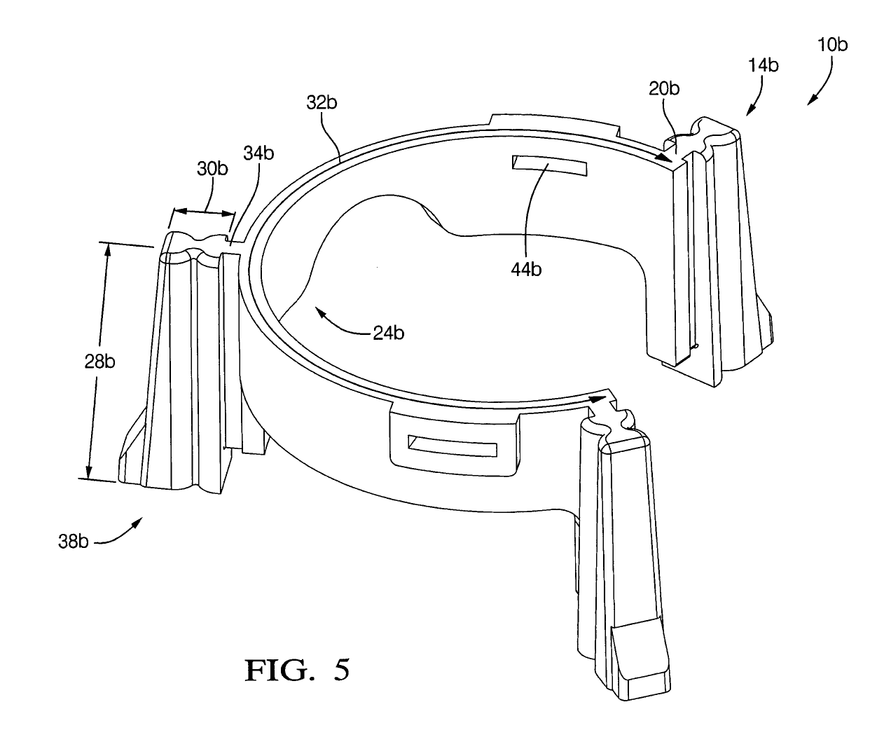

Referring now to FIG. 5, in a third exemplary embodiment of the invention, an isolator 10b is operable to isolate vibration associated with an electric motor, such as electric motor 12 associated with the first exemplary embodiment of the invention. The isolator 10b includes a first body portion 14b operable to be positioned adjacent to an external surface of a motor case, such as external surface 16 and motor case 18 associated with the first exemplary embodiment of the invention, of the electric motor. The first body portion 14b extends a first length 28b and defines a first height 30b. The isolator 10b also includes a tongue 20b integrally formed with and narrower than the first body portion 14b. The tongue 20b is operable to be received in a groove, such as groove 22 associated with the first exemplary embodiment of the invention, formed in the motor case. The isolator 10b also includes a second body portion 24b integrally formed with and wider than the tongue 20b. The second body portion 24b is operable to be disposed adjacent an internal surface, such as internal surface 26 associated with the first exemplary embodiment of the invention, of the motor case. As a result, at least a portion of the motor case of the electric motor is disposed between the first and second body portions 14b, 24b.

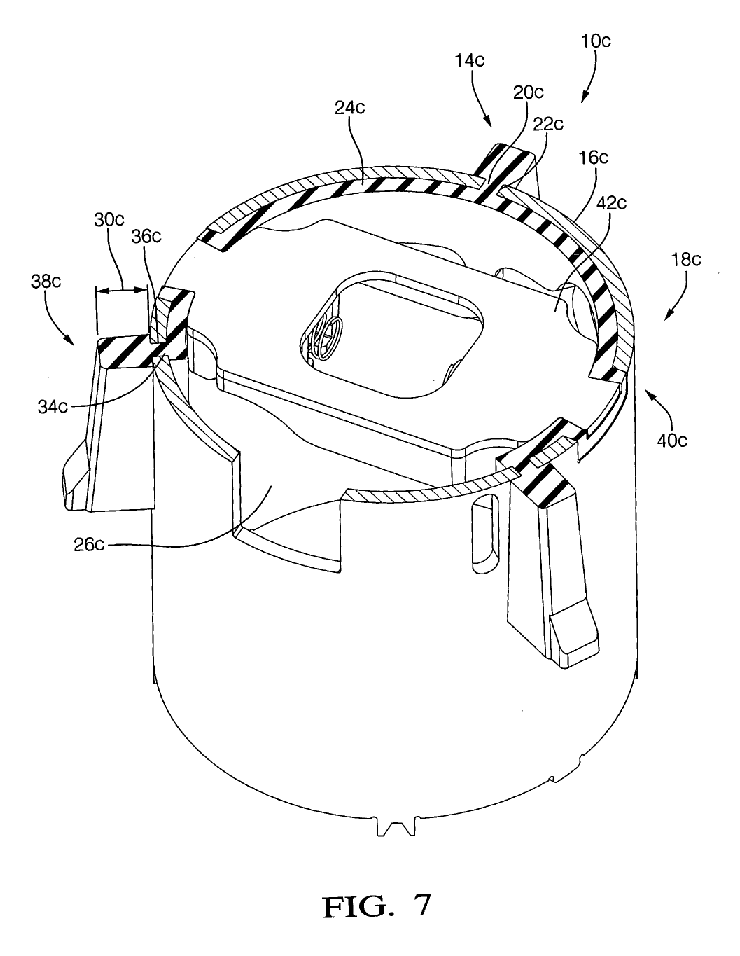

In the third exemplary embodiment of the invention, a plurality of outer body portions, such as first body portion 14b, are integrally formed together. The second body portion 24b extends along a substantially annular path 32b corresponding to the internal surface of the motor case. A second tongue 34b is integrally formed with the second body portion 24b and is spaced from the tongue 20b along the annular path 32b. The second tongue 34b is narrower than the second body portion 24b and is operable to be received in a second groove formed in the motor case. A third body portion 38b is integrally formed with the second tongue 34b and is operable to be positioned adjacent to the external surface of the motor case of the electric motor. The third body portion 38b is shaped substantially similar to the first body portion 14b. The second body portion 24b also includes at least one aperture 44b operable to receive a portion of a brush card, such as brush card 42c as shown in FIG. 7, whereby the second body portion 24b vibrationally isolates the brush card from the motor case.

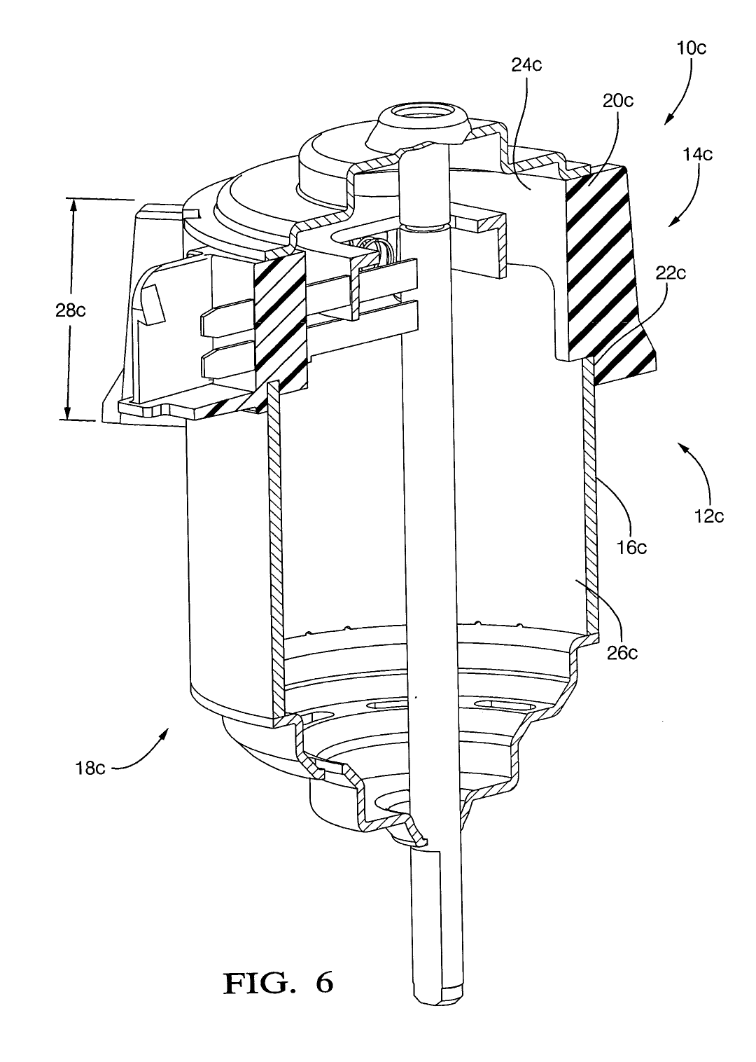

Referring now to FIGS. 6-7, in a fourth exemplary embodiment of the invention, an isolator 10c is operable to isolate vibration associated with an electric motor 12c. The isolator 10c includes a first body portion 14c operable to be positioned adjacent to an external surface 16c of a motor case 18c of the electric motor 12c. The first body portion 14c extends a first length 28c and defines a first height 30c. The isolator 10c also includes a tongue 20c integrally formed with and narrower than the first body portion 14c. The tongue 20c is operable to be received in a groove 22c formed in the motor case 18c. The isolator 10c also includes a second body portion 24c integrally formed with and wider than the tongue 20c. The second body portion 24c is operable to be disposed adjacent an internal surface 26c of the motor case 18c. As a result, at least a portion of the motor case 18c of the electric motor 12c is disposed between the first and second body portions 14c, 24c.

In the fourth exemplary embodiment of the invention, a plurality of outer body portions, such as first body portion 14c, are integrally formed together. The second body portion 24c extends along a substantially annular path, such as annular path 32b, corresponding to the internal surface of the motor case 18c. A second tongue 34c is integrally formed with the second body portion 24c and is spaced from the tongue 20c along the annular path. The second tongue 34c is narrower than the second body portion 24c and is operable to be received in a second groove 36c formed in the motor case 18c. A third body portion 38c is integrally formed with the second tongue 34c and is operable to be positioned adjacent to the external surface 16c of the motor case 18c of the electric motor 12c. The third body portion 38c is shaped substantially similar to the first body portion 14c. The second body portion 24c also includes at least one notch 40c operable to receive a portion of a brush card 42c whereby the second body portion 24c vibrationally isolates the brush card 42c from the motor case 18c.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An isolator for isolating vibration associated with an electric motor comprising:
a first body portion operable to be positioned adjacent to an external surface of a motor case of the electric motor;
a tongue integrally formed with and narrower than said first body portion and operable to be received in a groove formed in the motor case; and
a second body portion integrally formed with and wider than said tongue and operable to be disposed adjacent an internal surface of the motor case whereby at least a portion of the motor case of the electric motor is disposed between said first and second body portions.

2. The isolator of claim 1 wherein said first body portion is further defined as being longer than said second body portion.

3. The isolator of claim wherein said tongue is further defined as being shorter than at least one of said first and second body portions.

4. The isolator of claim 1 wherein said first and second body portions extend substantially straight and parallel to one another.

5. The isolator of claim 1 wherein said first body portion is further defined as extending a first length and as having an hour-glass cross-section along at least a portion of said first length.

6. The isolator of claim 1 wherein said first body portion is further defined as extending a first length and as having a first height being variable along said first length.

7. The isolator of claim 6 wherein said first height continuously increases along said first length.

8. The isolator of claim 7 wherein said first height is further defined as increasing at first rate along a first portion of said first length and as increasing at second rate greater than said first rate along a second portion of said first length adjacent to said first portion.

9. The isolator of claim 1 wherein said second body portion is further defined as extending along a substantially annular path corresponding to the internal surface of the motor case.

10. The isolator of claim 9 further comprising:
a second tongue spaced from said tongue along said annular path and integrally formed with and narrower than said second body portion and operable to be received in a second groove formed in the motor case;
a third body portion integrally formed with said second tongue and operable to be positioned adjacent to the external surface of the motor case of the electric motor.

11. The isolator of claim 10 wherein said third body portion is shaped substantially similar to said first body portion.

12. The isolator of claim 9 wherein said second body portion further comprises:
at least one notch operable to receive a portion of a brush card of the electric motor whereby said second body portion vibrationally isolates the brush card from the motor case.

13. The isolator of claim 12 wherein said second body portion further comprises:
at least one aperture operable to receive a portion of a brush card of the electric motor whereby said second body portion vibrationally isolates the brush card from the motor case.

14. An electric motor comprising:
a motor case having an external surface and an internal surface and a first groove extending between said external surface and said internal surface;
a first body portion operable to be positioned adjacent to said external surface of said motor case of the electric motor;
a tongue integrally formed with and narrower than said first body portion and operable to be received in said first groove formed in said motor case; and
a second body portion integrally formed with and wider than said tongue and operable to be disposed adjacent said internal surface of said motor case whereby at least a portion of said motor case of the electric motor is disposed between said first and second body portions.

15. The electric motor of claim 14 wherein said second body portion is further defined as extending along a substantially annular path corresponding to said internal surface of said motor case.

16. The electric motor of claim 15 further comprising:
a second groove formed in said motor case spaced from said groove;
a second tongue spaced from said tongue along said annular path and integrally formed with and narrower than said second body portion and operable to be received in said second groove;
a third body portion integrally formed with said second tongue and operable to be positioned adjacent to said external surface of said motor case.

17. The electric motor of claim 16 further comprising:
a brush card disposed in said motor case;
a plurality of notches formed in said second body portion and evenly spaced about said substantially annular path wherein each of said notches being operable to receive a portion of said brush card whereby said second body portion vibrationally isolates the brush card from the motor case.

18. The electric motor of claim 17 wherein each of said first body portion and said third body portion is further defined as extending respective first and third lengths and as having a respective first and third heights continuously increasing along said respective first and third lengths.

19. The electric motor of claim 18 wherein each of said first body portion and said third body portion is further defined as having an hour-glass cross-section along at least a portion of said respective first and third lengths.

20. The electric motor of claim 19 wherein at least one of said plurality of notches is disposed between said first and third body portion relative to said substantially annular path.
